(19) United States
(12) Patent Application Publication
(10) Pub. No.: US 2013/0254017 A1
(43) Pub. Date: Sep. 26, 2013

(54) SYSTEM FOR INFLUENCING THE BUYING PREFERENCES OF USERS

(71) Applicant: Kelsey Jack, Stamford, CT (US)

(72) Inventor: Kelsey Jack, Stamford, CT (US)

(21) Appl. No.: 13/424,899

(22) Filed: Mar. 20, 2012

(51) Int. Cl. G06Q 30/02

(52) U.S. Cl. 705/14.44

(57) ABSTRACT

Disclosed is a system for enabling first users to influence the preferences of second users in the favor thereof. Each first user represents a part or the entirety of a business entity and each second user representing an individual or an organization. The system comprises a plurality of preference polls accessible by a second user wherein, each preference poll requires a second user to select a poll entry out of at least two poll entries listed therein; each poll entry managed by a first user. The system further comprises a communication module for enabling the first users to persuade those second users, who have not selected the poll entries thereof, to reselect the poll entries thereof as preferred poll entries.

### BACKGROUND

The present invention relates to online systems that involve more than one type of client-side users, and more particularly to an online system for influencing the buying preferences of general public.

It's no news that today's businesses are cut-throat competitive. The marketing activity, which is one of the pillars of a business, is done through a lot of mediums, of which, the Internet is becoming increasing powerful in terms of the impact thereof. A proof of this is the well known fact that the popular sites like Facebook and Twitter have become a part of every business' marketing strategy and therefore, many of the businesses' marketing campaigns are centered around these networking sites although they are social networking sites at their core and therefore, are not dedicatedly built to facilitate an interaction between businesses and general public. A networking site that is solely built to provide an interface between businesses and general public is yet to be known in the art.

### SUMMARY

The present invention comprises an Internet-based system for enabling businesses—both B2B and B2C—to understand and to influence the buying preferences of their existing and prospective customers. The system of the present invention comprises a plurality of public preference polls, each requiring a second user to select a preferred poll entry out of at least two poll entries wherein, a poll entry might comprise an individual product or service offered a brand, a line of products or services offered by a brand, or an entire range of products or services offered by a brand. The second user represents an existing or a prospective customer. A poll entry and all that is represented by it is managed by a first user, who represents a business. In one embodiment, the system enables a first user to incentivize those second users, who have not selected the poll entries of the first user as preferred poll entries, in exchange for reselecting the poll entries thereof as preferred poll entries. A delivery module adapted to deliver the incentives upon the reselection.

The objects and advantages of the embodiments herein will become readily apparent from the following detailed description taken in conjunction with the accompanying drawings.

### BRIEF DESCRIPTIONS OF THE DRAWINGS

FIG. 1 is a block diagram of the online system of present invention.

FIG. 2 is a screenshot of exemplary preference polls.

FIG. 3 is a flowchart depicting the method of the online system.

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The present invention comprises an Internet-based system for enabling individuals and organizations to express the buying preferences thereof and businesses to influence the buying preferences in the favor thereof. More particularly, the buying preferences are influenced by incentivizing the individuals and organizations by providing discounts, reward points, rebates, cashbacks, freebies, and etc, which are widely known in the art.

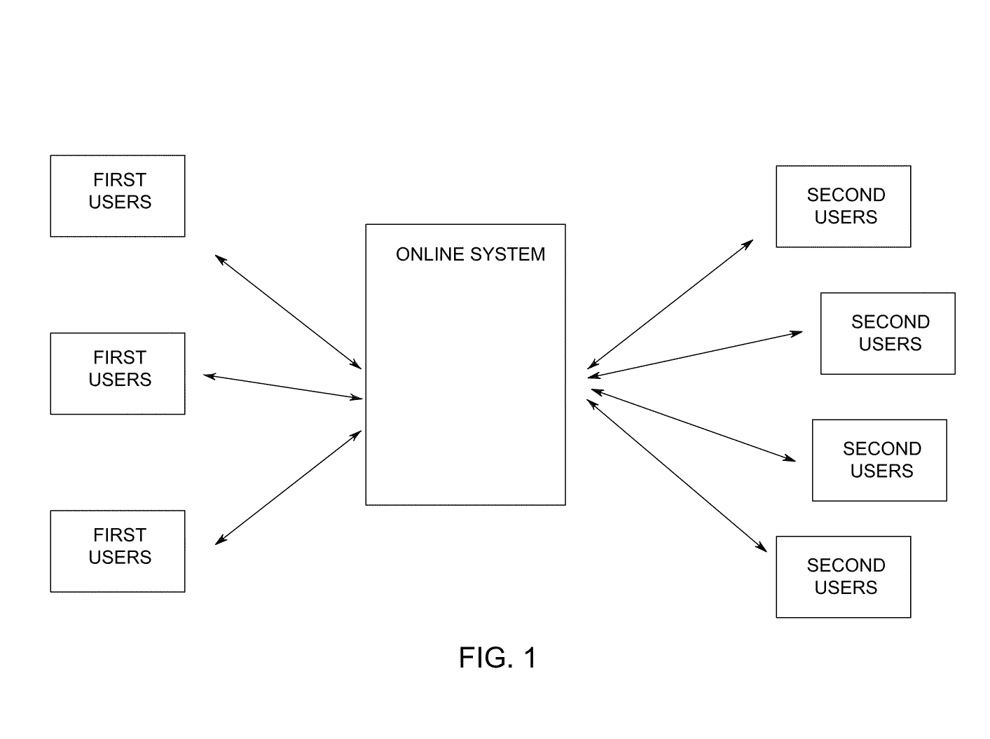

The system of the present invention clearly involves two types of client-side parties or users referred to as first and second users as shown in FIG. 1 wherein, the first users represent business entities, and the second users represent existing and prospective customers, who comprise public and organizations such as businesses, and NGOs. Each first user (generally representing a business entity or entities) manages at least one product or service wherein, each of the at least one product or service is offered by a brand and wherein, in the case where the at least one product or service comprises more than one product or service, the brands pertaining to the more than one product or service may not necessarily be the same. An example for managing more than one product or service would be a first user (generally representing a business entity or entities) managing a gaming console from Sony™ along with a tablet from Samsung™ at the same time.

The system also enables the first user (generally representing a business entity or entities) to manage at least one line or category of products or services wherein, the at least one line of products or services may be offered by a same or different brands. An example for a first user (generally representing a business entity or entities) managing more than one line of products or services would be managing a line of cellular phones from Samsung™ and a line of apparels from Nike™. In the similar way, a first user (generally representing a business entity or entities) is also enabled by the system to manage at least one brand, which comprises the entire range of products or services offered by that brand. Further, the first user (generally representing a business entity or entities) can also manage a combination of the individual products or services, line of products or services, and the entire brand of products. For example, a first user (generally representing a business entity or entities) may manage the brand McDonalds™, along with the apparel line of Nike™ and a gaming console from Sony™.

In one embodiment, the first users (generally representing a business entity or entities) also represent groups, such as, rock bands, circus groups, etc, and even individuals such as celebrities, and the second users (generally representing a customer or customers) may represent fans in accordance with the embodiment. In this embodiment, for example, a first user (generally representing a business entity or entities) representing a group comprising a rock band may manage its recently released album or single. In another example, a group or a celebrity may manage their brand or self-image.

The system comprises a registration module for either party to register therewith so as to become the registered members thereof when logged thereinto post the registration. The registration is complete when the registration details provided by either party are validated by the system. The registration details provided by the second users (generally representing a customer or customers) could be just the identification details such as name and email address. However, the first users (generally representing a business entity or entities) need to produce, along with the identification details thereof, business details of whatever they intend to manage through the system. The business details could include the product(s) and/or service(s), the line(s) of products or services, or the brand(s) managed by the first user (generally representing a business entity or entities), the category of the products or services, the product(s) and/or service(s) or the line(s) of products or services pertains to, and so on. In one embodiment, the registration details provided by any client-side user includes a signature line thereof, which could be a quote, a caption, and the like, wherein, the signature line is associated with the identity thereof. For example, the caption “Make. Believe” may be associated with a first user Sony™. Similarly, for example, the identity of a second user (generally representing a customer or customers), who comprises an individual, may be associated with his/her favorite movie quote.

A first user (generally representing a business entity or entities), upon registration, is enabled to include whatever he/she manages as a poll entry upon which, the individual product(s) and/or service(s), the line(s) of products or services, or the brand(s) managed by the first user (generally representing a business entity or entities) become eligible to be a part of a preference poll along with other competing individual product(s) and/or service(s), the line(s) of products or services, or the brand(s) managed by other first users (generally representing a business entity or entities). The preference polls are of three types, viz., a product poll, a line poll, and a brand poll. The product poll comprises at least two competing individual products or services pitted against each other wherein, each of the individual products or services within the product poll are equivalent in terms of the utility thereof and are offered by different brands (hence the mention of “competing”). An example of a product poll would be where a SonyPlaystation 3™, Nitendo Wii™, and a Microsoft Xbox 360™ are pitted against one another. The line poll comprises at least two lines of equivalent products or services offered by competing brands pitted against each other. An example of a line poll would be a preference poll where Nike™, Adidas™, and Puma™'s line of footwear are pitted against each other. Finally, the brand poll, as the term suggests, comprises at least two rival brands pitted against each other. An example of a brand poll would be where McDonalds™ is pitted against Burger King™. It is obvious that no two poll entries within a preference poll are managed by a same first user (generally representing a business entity or entities).

In one embodiment, a preference poll further comprises a generic poll comprising at least two generic items pitted against each other as poll entries. An example of a generic poll would be a poll where coffee and tea are pitted against one another. Boxers versus briefs would be another example of a generic poll. The generic poll and the entries thereof are completely managed by the system itself. The purpose of the generic poll is to understand the buying preferences of customers. For example, a generic poll that featured boxers and briefs as poll entries might give a garments company an insight into the customers' preferences.

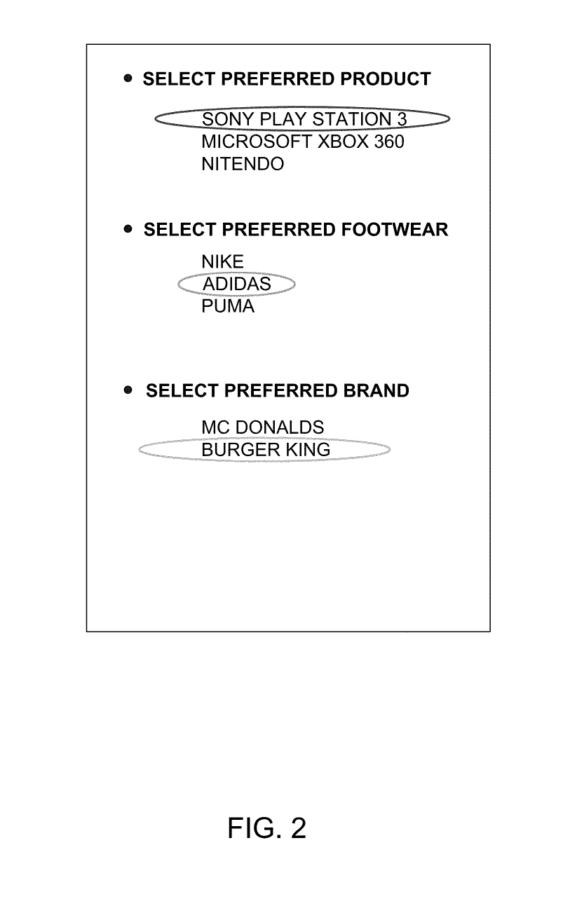

A second user (generally representing a customer or customers), upon becoming the registered member of the system, will have access to the preference polls of all types wherein, a second user (generally representing a customer or customers) is required to select one poll entry out of at least two poll entries listed within a preference poll. The selection of poll entries is reversible so that a second user (generally representing a customer or customers) can change his/her selection upon his/her discretion. Further, the second user (generally representing a customer or customers) has an option to select a preferred poll entry with various degrees of preference viz., high, medium, and low. Selecting a poll entry with a high degree of preference implies that the second user (generally representing a customer or customers) is loyal to the individual product or service, line of products or services, or the brand represented by the poll entry and his/her selection is non-negotiable. If a second user (generally representing a customer or customers) selects a poll entry with medium or low preference, it means that the second user (generally representing a customer or customers) can be persuaded to change his/her preference but with some difficulty in case of the medium preference selection and easily in case of the low preference selection. In one embodiment, the high, medium, and low degree of preference are represented, for example, by red, green, and yellow colored halos respectively encircling the preferred poll entry, an example of which is shown in FIG. 2.

The system further provides a first user (generally representing a business entity or entities) with a communication means within the system so as to enable a first user (generally representing a business entity or entities) to communicate with those second users (generally representing a customer or customers), who have not selected the first user's (generally representing a business entity or entities) poll entry as preferred poll entry, proposing them to reselect the first user's (generally representing a business entity or entities) poll entry as preferred poll entry in exchange for providing shopping incentives such as discounts, reward points, rebates, cashback, freebies, and etc. The scale of incentive provided by the first user (generally representing a business entity or entities) depends on the degree of preference with which the second users (generally representing a customer or customers) has selected a poll entry other than the first user's poll entry. More particularly, the scale of incentive offered for a second user (generally representing a customer or customers), who has selected a poll entry over the first user's (generally representing a business entity or entities) poll entry with low preference, will be lower than that of a second user (generally representing a customer or customers), who has selected a poll entry over the poll entry of the first user (generally representing a business entity or entities) with a medium degree of preference. A second user (generally representing a customer or customers), who selected a poll entry over the first user's (generally representing a business entity or entities) poll entry with a high degree of preference, may not attract any incentives from the first users (generally representing a business entity or entities) as high preference, as mentioned earlier, denotes that that second user's choice is non-negotiable. However, in one embodiment, a first user (generally representing a business entity or entities) might incentivize the second users, who have selected the poll entry thereof as preferred poll entry with a high degree of preference thereby recognizing the second user's (generally representing a customer or customers) strong affinity therewith. The communication means may comprise an email or a simple text message sent to the account of the second users (generally representing a customer or customers) wherein, the account of the second user (generally representing a customer or customers) is automatically created by the system upon the registration thereof. In one embodiment, the communication means comprises an email, which is managed by third party email service providers such as a Yahoo™, Google™, and the like.

In one embodiment, instead of incentivizing the second users (generally representing a customer or customers), the first users (generally representing a business entity or entities) may persuade to the second users (generally representing a customer or customers), who have not selected the poll entry or entries thereof as preferred poll entry or entries, by providing a ‘justification’ as to why the poll entry or entries thereof is better and therefore, should be selected in lieu of the other poll entries. For example, a first user (generally representing a business entity or entities) might persuade a second user (generally representing a customer or customers) to change his/her preference by citing that the business represented by the poll entry thereof is eco-friendlier than the businesses represented by the other poll entries.

The communication means further comprises a delivery module for delivering the incentives issued by the first user (generally representing a business entity or entities) to those second users (generally representing a customer or customers) that have accepted the proposal thereof by to reselecting the first user's (generally representing a business entity or entities) poll entry as preferred poll entry. In one embodiment, the incentives are delivered to the second users (generally representing a customer or customers) only after a predetermined time from the reselection of the first user's (generally representing a business entity or entities) poll entry so as to ensure that the second users (generally representing a customer or customers) does not change his/her preference again immediately upon receiving the incentive from the first user (generally representing a business entity or entities). The system of the present invention can also be implemented on other platforms, such as on cellular phones, and etc.

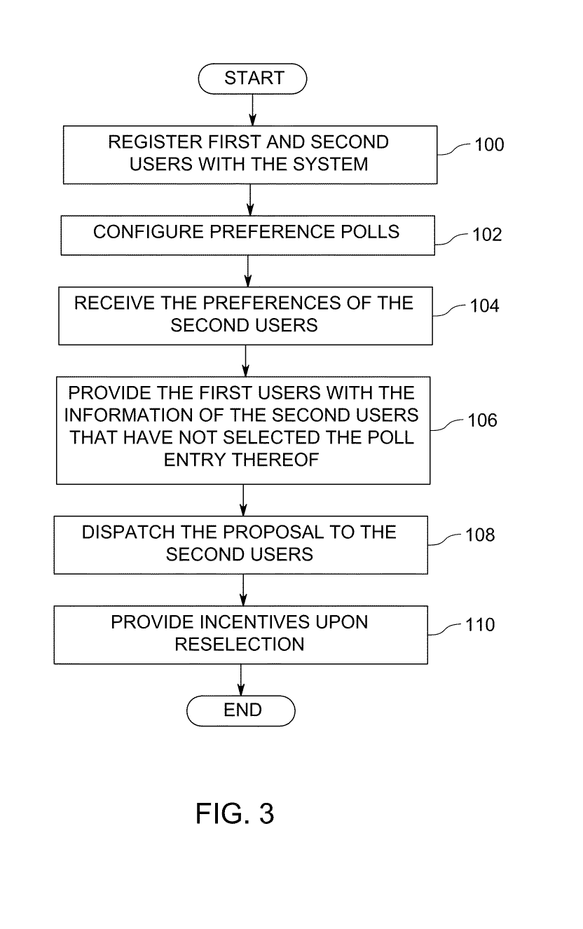

Referring to FIG. 3, briefly, the preferred embodiment of the method of the system initiates with the system comprises registering a first and second user therewith upon providing valid registration details. Upon registration, the system configures public preference polls in accordance with the poll registration details provided by the first users (generally representing a business entity or entities). Once the preference polls are configured, a second user (generally representing a customer or customers) can access the preference polls and select his/her preferred poll entries over other poll entries listed therein. A first user (generally representing a business entity or entities) is enabled access those second users (generally representing a customer or customers), who have not selected the poll entries thereof as preferred poll entries, and propose to them to reselect the poll entries thereof in exchange for providing shopping incentives, such as discounts, reward points, rebates, cashback, freebies, and the like. The system delivers the incentives issued by the first user (generally representing a business entity or entities) to the second users (generally representing a customer or customers) upon the reselection.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall therebetween.

What is claimed is:

1. A system for enabling first users to influence the preferences of second users in the favor of the first users, each first user representing a part or the entirety of a business entity, each second user representing an individual or an organization, the system comprising:
(a) a plurality of preference polls accessible by a second user, each preference poll requiring a second user to select a poll entry out of at least two poll entries listed therein, each poll entry managed by a first user; and
(b) a communication means for enabling the first users to persuade those second users, who have not selected the poll entries thereof, to reselect the poll entries thereof as preferred poll entries.

2. The system of claim 1 wherein, the second users are persuaded by the first users by offering incentives, which are delivered by the communication module upon the reselection.

3. The system of claim 2 wherein, the incentives are delivered upon the completion of a predetermined time period from the point of reselection.

4. The system of claim 1 wherein, each poll entry represents a product or service offered by the part or the entirety of the business entity the first user pertaining thereto represents.

5. The system of claim 4 wherein, a preference poll is configured such that the products or services represented by the poll entries listed therewithin are substantially equivalent in terms of the utility thereof.

6. The system of claim 1 wherein, each poll entry represents a line of products or services offered by the part or the entirety of the business entity the first user pertaining thereto represents.

7. The system of claim 6 wherein, a preference poll is configured such that the lines products or services represented by the poll entries listed therewithin are substantially equivalent in terms of the utility thereof.

8. The system of claim 1 wherein, each poll entry represents the entire range products or services offered the part or the entirety of the business entity the first user pertaining thereto represents; the entire range of products or services represented as a brand.

9. The system of claim 8 wherein, a preference poll is configured such that the brands represented by the poll entries listed therewithin are competing brands.

10. The system of claim 1 being implemented on the Internet.

11. The system of claim 1 wherein, each preference poll is further configured such that no two poll entries listed therewithin are managed by same first user.

12. The system of claim 1 wherein, each of the first and the second users are associated with a self-chosen signature line.

13. The system of claim 1 wherein, the communication means comprises an email provided by email providers.

14. The system of claim 1 wherein, the second users are persuaded by providing a justification by the first users as to why the poll entry thereof warrants a reselection.

15. A system for enabling first users to influence the buying preferences of second users in the favor thereof, each first user representing a part or the entirety of a business entity, each second user representing an individual or an organization, the system comprising:
(a) plurality of public preference polls accessible by a second user, each preference poll requiring a second user to select a preferred poll entry out of at least two poll entries listed therein wherein, each poll entry represents a product or service offered by a brand, a line of products or services offered by a brand, or an entire range of products or services offered by a brand, and wherein, each poll entry is managed by a first user, each preference poll configured such that, the products or services offered by the brands represented by the poll entries listed therein are substantially equivalent in terms of the utility thereof; and
(b) a communication means for enabling the first users to persuade those second users, who have not selected the poll entries thereof, to reselect the poll entries thereof as preferred poll entries.

16. A method for enabling first users to influence the preferences of second users in the favor thereof, each first user representing a part or the entirety of a business entity, each second user representing an individual or an organization, the system comprising:
(a) providing a plurality of public preference polls accessible by a second user, each preference poll requiring a second user to select a preferred poll entry out of at least two poll entries listed therein, each poll entry managed by a first user; and
(b) providing a communication means for enabling the first users to persuade those second users, who have not selected the poll entries thereof, to reselect the poll entries thereof as preferred poll entries.

17. The method of claim 14 wherein, the second users are persuaded by the first users by offering incentives, which are delivered by the communication module upon the reselection.

18. The method of claim 15 wherein, the incentives are delivered upon the completion of a predetermined time period from the point of reselection.

19. The method of claim 14 wherein, each poll entry represents a product or service offered the part or the entirety of the business the first user pertaining thereto represents.

20. The system of claim 17 wherein, a preference poll is configured such that the products or services represented by the poll entries listed therewithin are substantially equivalent in terms of the utility thereof.

21. The method of claim 14 wherein, each poll entry represents a line of products or services offered the part or the entirety of the business the first user pertaining thereto represents.

22. The method of claim 19 wherein, a preference poll is configured such that the lines products or services represented by the poll entries listed therewithin are substantially equivalent in terms of the utility thereof.

23. The method of claim 14 wherein, each poll entry represents the entire range products or services offered the part or the entirety of the business entity the first user pertaining thereto represents; the entire range of products or services represented as a brand.

24. The method of claim 21 wherein, a preference poll is configured such that the brands represented by the poll entries listed therewithin are competing brands.

25. The method of claim 14 wherein, each preference poll is further configured such that no two poll entries listed therewithin is managed by same first user.

26. The method of claim 14 being implemented on the Internet.

27. The method of claim 14 wherein, the communication means comprises an email provided by third party email service providers.

28. The method of claim 14 wherein, each of the first and the second users are associated with a self-chosen signature line.

29. The method of claim 14 wherein, the second users are persuaded by providing a justification by the first users as to why the poll entry thereof warrants a reselection.

30. An online method for enabling first users to influence the buying preferences of second users in the favor thereof, each first user representing a part or the entirety of a business entity, each second user representing an individual or an organization, the system comprising:
(a) providing a plurality of public preference polls accessible by a second user, each preference poll requiring a second user to select a preferred poll entry out of at least two poll entries listed therein wherein, each poll entry represents a product or service offered by a brand, a line of products or services offered by a brand, or an entire range of products or services offered by a brand, and wherein, each poll entry is managed a first user, each preference poll configured such that, the products or services offered by the brands represented by the poll entries listed therein are substantially equivalent in terms of the utility thereof; and
(b) providing a communication means for enabling the first users to persuade those second users, who have not selected the poll entries thereof, to reselect the poll entries thereof as preferred poll entries.
